(19) United States
(12) Patent Application Publication
(10) Pub. No.: US 2018/0219379 A1
(43) Pub. Date: Aug. 2, 2018

(54) POWER PLANT INSTALLATION

(71) Applicant: Siemens Aktiengesellschaft, Muenchen (DE)

(72) Inventors: Stefan HENNINGER, Fuerth (DE); Johann JAEGER, Erlangen (DE); Uwe KREBS, Hirschaid (DE); Karsten RECHENBERG, Dormitz (DE); Hubert RUBENBAUER, Bubenreuth (DE); Markus SCHROEDER, Bamberg (DE)

(73) Assignee: Siemens Aktiengesellschaft, Muenchen (DE)

(21) Appl. No.: 15/506,024

(22) PCT Filed: Sep. 25, 2014
(86) PCT No.: PCT/EP2014/070545

§ 371 Date: Feb. 23, 2017

(51) Int. Cl. H02J 3/32; H02J 3/38; H02J 3/14

(52) U.S. Cl. CPC H02J 3/32; H02J 3/14; H02J 3/38

(57) ABSTRACT

A power plant installation includes a feed connection for feeding energy into an external energy supply grid and at least one energy-generating unit. The power plant installation includes at least one energy storage unit and at least one isolated component grid which is connected to the feed connection via a converter of the power plant installation and is electrically isolated from the feed connection and the external energy supply grid by the converter, the at least one energy-generating unit and/or the at least one energy storage unit are connected to the isolated component network, and the powerplant installation has a control device which, by actuating the converter, the energy-generating unit and/or the energy storage unit, adjusts the feed behaviour of the power plant installation which is effective towards the outside at the feed connection.

### PRIORITY STATEMENT

This application is the national phase under 35 U.S.C. § 371 of PCT International Application No. PCT/EP2014/070545 which has an International filing date of Sep. 25, 2014, which designated the United States of America, the entire contents of which are hereby incorporated herein by reference.

### FIELD

An embodiment of invention generally relates to a power plant installation having an infeed connection, for feeding energy into an external energy supply grid, and at least one energy-generating unit, for generating electrical energy.

### BACKGROUND

The prior connection practice of what in the specialist language are called renewable energies (RE) is inadequate, and results in ever greater problems in the electrical energy supply grid. These problems are characterized by two significant aspects: infeed that fluctuates with time, and connection points that, for the grid, are randomly distributed. Owing to this connection practice, renewable energies at present do not constitute a replacement for conventional power plants. Moreover, reliability of supply is jeopardized, e.g. because of overloading of operating equipment and voltage range deviations, and high fluctuations occur in the price of electricity, sometimes even negative electricity prices.

Hitherto, there has been no known holistic approach to solving the above-mentioned problem. Mostly, only partial aspects are solved, or the symptoms, rather than the causes, are remedied. Thus, for example, the use of intelligent operating equipment, such as controllable distribution transformers, solves only the symptom “voltage range deviation”, but not the cause thereof.

Although further so-called “smart grid” approaches, such as adjusting the load to the generation (called “demand side management” in the specialist language) do contribute somewhat toward the evening-out of fluctuating infeed, they likewise do not solve the fundamental problem since, to maintain most commercial and social processes, it is still necessary for generation to follow demand, and not vice versa. Also, the increased use of information technology, smart meters etc. does not remedy the main problem of regenerative infeed, namely, the fluctuating character and its local distribution.

A further known solution approach resides in grid expansion (in particular in the distribution grid), if regenerative infeeds can overload operating equipment or jeopardize the (n−1) reliability. Although local bottlenecks are remedied as a result, these measures are nevertheless very expensive and often over-dimensioned, since they are not designed for the nominal power of the regenerative infeeds, even if the latter occur only at a few points in the year. Also not to be disregarded is the problem of acceptance of new electricity lines in the population.

### SUMMARY

The inventors recognize that So-called “virtual” power plants address the problem of fluctuating infeed in that, by corresponding coordination of spatially distributed infeeds and storages, they cause an infeed behavior to be generated that can be regulated in aggregate. This, however, necessitates a large amount of communication resource. However, the randomly distributed connection of the operating equipment in the grid and the problems associated therewith—such as jeopardized reliability of supply, voltage range deviations, high grid expansion costs, etc.—are not remedied.

Overall, therefore, the inventors recognize at present there is not yet any concept that fully addresses and remedies the problems of regenerative infeed.

At least one embodiment of the invention accordingly includes specifying a power plant installation in which at least one of the above-mentioned problems in the infeed of regenerative energy are reduced in comparison with conventional power plant installations.

At least one embodiment of the invention is directed to a power plant installation. Advantageous developments of the power plant installation according to the invention are specified in dependent claims.

It is accordingly provided, according to at least one embodiment of the invention, that the power plant installation has at least one energy-generating unit, at least one energy storage unit, and at least one decoupled sub-grid, which is connected to the infeed connection via a converter of the power plant installation and is electrically decoupled from the infeed connection and the external energy supply grid by the converter, the at least one energy-generating unit and/or the at least one energy storage unit are connected to the decoupled sub-grid, and the power plant installation has a controller that, by controlling the converter, the energy generating unit and/or the energy storage unit, adjusts the infeed behavior of the power plant installation acting outwardly on the infeed connection.

At least one embodiment of the invention additionally relates to a method for operating a power plant installation that is connected to an external energy supply grid via an infeed connection and that has at least one energy-generating unit.

With regard to such a method, it is provided according to at least one embodiment of the invention that the energy of the at least one energy-generating unit and/or energy of at least one energy storage unit of the power plant installation is fed into an own sub-grid of the power plant, wherein the energy of the at least one energy-generating unit is fed into the external energy supply grid either directly, via the infeed connection, or via a converter and the infeed connection, or -entirely or at least in part—stored intermediately in the at least one energy storage unit.

### BRIEF DESCRIPTION OF THE DRAWINGS

The invention is explained more fully in the following on the basis of example embodiments, wherein there are shown, by way of example:

FIG. 1 the present-day usual connection practice in the case of use of renewable energies,

FIG. 2 an example embodiment for a power plant installation according to the invention,

FIG. 3 an example embodiment for a power plant installation according to the invention, having a decoupled sub-grid that has an energy-generating unit and an energy storage unit,

FIG. 4 an example embodiment for a power plant installation according to the invention, having a decoupled sub-grid that has an energy storage unit, and having a directly coupled sub-grid that has an energy-generating unit,

FIG. 5 an example embodiment for a power plant installation according to the invention, having a decoupled sub-grid that has an energy-generating unit, and having a directly coupled sub-grid that has an energy storage unit,

FIG. 6 an example embodiment for a power plant installation according to the invention, which has various energy-generating and energy storage units, a decoupled, DC-based (direct-voltage) sub-grid, a modular multilevel converter having integrated batteries, as a converter, and a directly coupled, AC-based (alternating-voltage) sub-grid,

FIG. 7 an example embodiment for a power plant installation according to the invention, having various energy-generating and energy storage units, a decoupled, DC-based sub-grid, an AC-DC converter, and a directly coupled, AC-based (alternating-voltage) sub-grid,

FIG. 8 an example embodiment for a power plant installation according to the invention, having various energy-generating and energy storage units, a decoupled, AC-based (alternating-voltage) sub-grid, an AC-AC converter, for example of the “SIPLINK” type by the company Siemens AG, and a directly coupled, AC-based (alternating-voltage) sub-grid,

FIG. 9 power variation curves of an example embodiment for a power plant installation according to the invention, for a week in April, and

FIG. 10 power variation curves of another example embodiment for a power plant installation according to the invention, for a week in April.

For reasons of clarity, in the figures the same references are used in each case for components that are identical or comparable.

### DETAILED DESCRIPTION OF THE EXAMPLE EMBODIMENTS

It is accordingly provided, according to at least one embodiment of the invention, that the power plant installation has at least one energy-generating unit, at least one energy storage unit, and at least one decoupled sub-grid, which is connected to the infeed connection via a converter of the power plant installation and is electrically decoupled from the infeed connection and the external energy supply grid by the converter, the at least one energy-generating unit and/or the at least one energy storage unit are connected to the decoupled sub-grid, and the power plant installation has a controller that, by controlling the converter, the energy generating unit and/or the energy storage unit, adjusts the infeed behavior of the power plant installation acting outwardly on the infeed connection.

A substantial advantage of the power plant installation according to at least one embodiment of the invention resides in that, owing to the dimensioning of the power plant installation, owing to the provided controlling of the converter, the energy generating unit and/or the energy storage unit, and owing to the provided decoupling of the sub-grid from the external energy supply grid, with regard to the infeed behavior at the common infeed connection, an optimum infeed can be achieved, even with use of regenerative energies. Thus, inside the power plant installation, the problems of energy infeed fluctuating with time can be reduced, and the effect on the external energy supply grid is less than in the case of present installations.

As already mentioned, the power plant installation is particularly suited to the use of regenerative energy-generating units. Accordingly, it is considered to be advantageous if the power plant installation has at least one regenerative energy-generating unit.

Preferably, the power plant installation has at least two regenerative energy-generating units, which differ from each other in respect of their energy-generating characteristic and/or their energy-generating technology. A differing energy-generating characteristic and/or energy-generating technology within the power plant installation helps to minimize fluctuations at the infeed connection. Wind power installations or photovoltaic installations, for example, may be used as regenerative energy-generating units.

Preferably, a reduction of fluctuations is at least also effected by energy storage. In this regard, it is considered to be particularly advantageous if the power plant installation has at least two energy storage units, which differ from each other in respect of their storage characteristic and/or their storage technology. Power-to-gas storages, or batteries, preferably in the form of redox flow batteries or lithium-ion batteries, for example, may be used as energy storage units. For example, lithium-ion and redox flow batteries are suitable as minute-storages and hour-storages; power-to-gas storages are suitable as long-duration storages, and are characterized by a large storage capacity.

Controlling of the energy-generating units and of the energy storage units is preferably effected by way of droop controllers, using electrical state variables, in the decoupled sub-grid, thereby making it possible to avoid the use of additional communication resources between the energy-generating units and/or energy storage units.

It is also considered to be advantageous if at least one sub-grid is directly coupled to the infeed connection of the power plant installation, and at least one energy storage unit and/or at least one energy-generating unit is connected to the directly coupled sub-grid.

Owing to the directly coupled sub-grid, properties of a conventional power plant installation (short-circuit power or mass inertia), can advantageously be integrated into the operating behavior of the power plant installation.

Preferably, the energy storage units connected to the directly coupled sub-grid and the energy-generating units connected to the directly coupled sub-grid each have a communication module that enables communication with the controller.

The controller, the energy storage units and the energy-generating units are preferably realized in such a manner that the power plant installation can run predefined infeed schedules, render predefined grid services and/or provide electrical energy having predefined electrical parameters.

It is also advantageous if the controller, the energy storage units and the energy-generating units are realized in such a manner that the infeed behavior of the power plant installation emulates the infeed behavior of a conventional power plant.

With regard to the disposition of the components, it is considered to be advantageous that the energy storage units and the energy-generating units are disposed at a distance from each other, and may be distributed in an urban area or a larger rural area. The distance between the two components of the power plant installation that are most distant from each other is preferably at least 5 km. The problem of the local distribution of regenerative infeed is thereby remedied, or at least alleviated.

Despite the spatial distribution of the energy storage units and energy-generating units, in comparison with the prior connection practice the requirement for new electricity lines is not substantially increased since at present, already, longer line sections are frequently required for grid connection, and these can be used for constructing a power plant installation according to at least one embodiment of the invention.

At least one embodiment of the invention additionally relates to a method for operating a power plant installation that is connected to an external energy supply grid via an infeed connection and that has at least one energy-generating unit.

With regard to such a method, it is provided according to at least one embodiment of the invention that the energy of the at least one energy-generating unit and/or energy of at least one energy storage unit of the power plant installation is fed into an own sub-grid of the power plant, wherein the energy of the at least one energy-generating unit is fed into the external energy supply grid either directly, via the infeed connection, or via a converter and the infeed connection, or -entirely or at least in part—stored intermediately in the at least one energy storage unit.

Preferably, the energy of the at least one energy storage unit is fed into an own sub-grid of the power plant that that is connected to the infeed connection via a converter of the power plant installation, and that is electrically decoupled from the infeed connection and the external energy supply grid by the converter.

With regard to the advantages of the method according to at least one embodiment of the invention, reference may be made to the explanations above concerning the power plant installation according to at least one embodiment of the invention.

It is considered to be advantageous if the proportion of energy that is stored intermediately is determined in dependence on a predefined infeed schedule or a predefined grid service.

Preferably, the controlling of the converter, the energy-generating units and the energy storage units is effected in such a manner that the infeed behavior of the power plant installation emulates the infeed behavior of a conventional power plant.

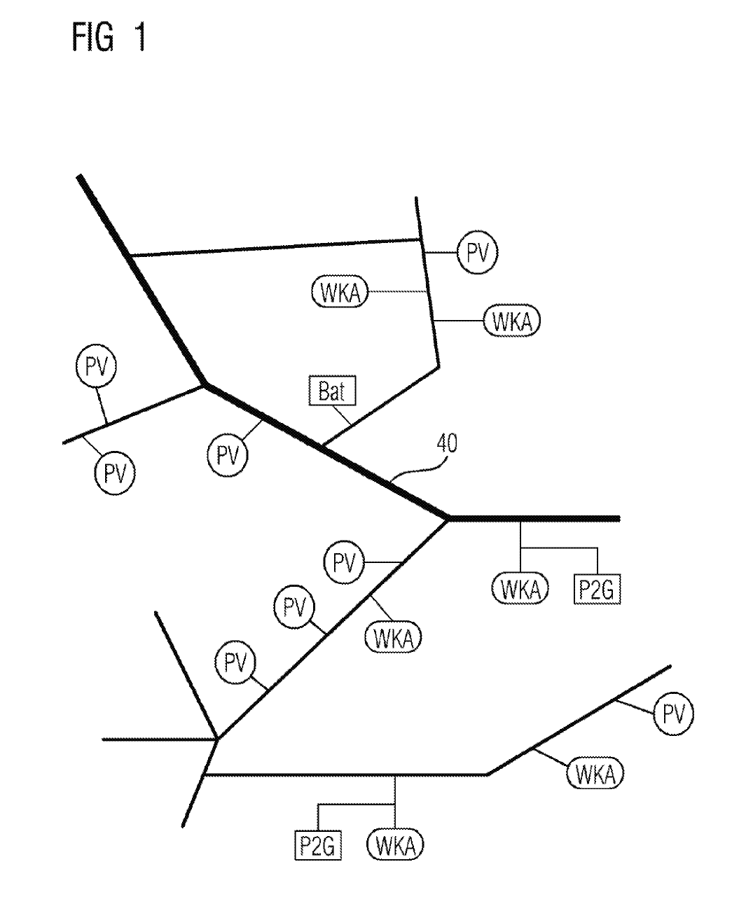

FIG. 1 shows, by way of example, the prior connection practice in the case of renewable energies. The figure shows a multiplicity of energy-generating units, in the form of wind power installations WKA, and photovoltaic installations PV, as well as a multiplicity of energy storage units, in the form of batteries Bat and power-to-gas installations P2G. The energy-generating units and the energy storage units are connected to various infeed points and, entirely independently from each other, to an energy supply grid 40. Shown clearly in FIG. 1 is the resultant spatially distributed and fluctuating infeed, with the problems already explained at the outset.

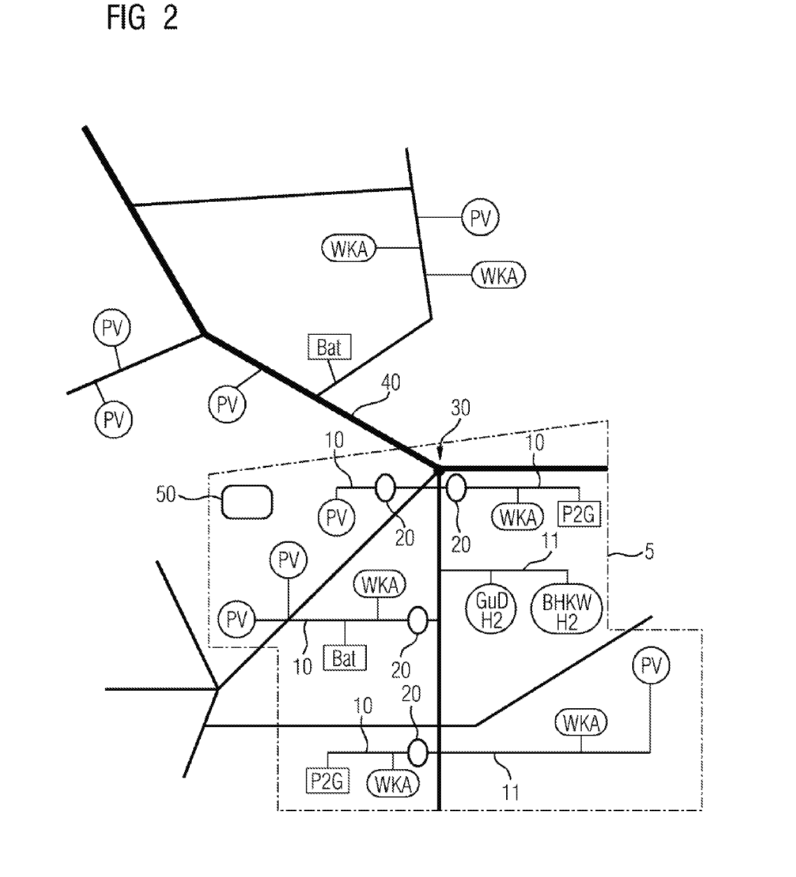

FIG. 2, for direct comparison, shows an example embodiment for a procedure according to an embodiment of the invention. The figure shows a power plant installation 5, which has at least one or—as shown—a plurality of decoupled sub-grids 10. The decoupled sub-grids 10 have respectively one or more energy-generating units and/or respectively one or more energy storage units, and are each decoupled, via a converter 20, from an infeed connection 30, via which the power plant installation 5 is connected to the external energy supply grid 40.

Furthermore, the power plant installation 5 according to FIG. 2 has two directly coupled sub-grids 11, which are directly connected, or connected without a decoupling converter, to the infeed connection 30.

The controlling of the energy-generating units and of the energy storage units of the sub-grids 10 and 11, and the controlling of the converters 20 of the sub-grids 10 is effected by a controller 50, which is connected to the energy-generating units, the energy storage units and the converters 20, whether via communication modules, not shown, or via droop controllers, not shown.

In the case of the example embodiment according to FIG. 2, the problems that occur in the case of the prior connection practice according to FIG. 1 are remedied, or at least alleviated, by the following features:

On the one hand, in the case of the example embodiment according to FIG. 2, the energy-generating units (e.g. gas and steam power plant installations GuD and engine-based cogeneration systems BHKW, which reconvert hydrogen H2, or wind power installations WKA) and the energy storage units are not connected individually and independently from one another at differing infeed points to the energy supply grid 40; instead, they are connected to interposed sub-grids 10 and 11, and via the latter are connected to the energy supply grid 40 at a single infeed connection 30, and in the case of the sub-grids there is even an additional decoupling in each case, effected by a converter 20. Owing to the interposed sub-grids 10 and 11, the behavior of a conventional power plant can advantageously be emulated at the (single) infeed connection 30, although the individual energy-generating units, in particular the regenerative units, each have an operating behavior that is significantly different from that of conventional power plants. In other words, the power plant installation 5 as a whole can run infeed schedules, render grid services and provide electrical energy according to demand, as would be provided at the infeed connection 30 by a conventional power plant 5. Because of this fact, fewer conventional power plants in total have to be kept available in order to secure and stabilize the grid operation in the overall energy supply grid 40, and more regenerative energy generation can be provided than is the case with the grid concept according to FIG. 1.

Furthermore, in the case of the example embodiment according to FIG. 2, various storage technologies (e.g. power-to-gas storages P2G or batteries Bat) are used in the sub-grids 10 and 11, to enable the regenerative energy generation fluctuating with time to be buffered, with regard to the desired energy infeed—with respect to the infeed connection 30—in a particularly effective manner.

It can additionally be seen from both FIGS. 1 and 2 that the locations of the energy-generating units and those of the energy storage units can remain the same, only the connection of the components to the external energy supply grid 40 being effected differently in the case of FIG. 2, namely, via the described sub-grids 10 and 11. The integration of further energy-generating and energy storage units is advantageous for the purpose of achieving a particular power plant behavior.

In particular, the decoupled sub-grids 10 enable the problems of a spatially distributed generation of regenerative energy that fluctuates with time to be significantly alleviated.

For the purpose of decoupling as fully as possible the infeed behavior of the power plant installation 5 at the infeed connection 30 from the fluctuating energy generation of its energy-generating units, various storage technologies are advantageous, which have differing characteristics in respect of storage capacity, dynamics, efficiency, etc. Thus, for example, lithium-ion and redox flow batteries are more suitable as minute and hour storages, whereas P2G systems are more suitable as long-duration storages, having a large storage capacity. The overall behavior can be optimized by corresponding dimensioning and coordination of the individual storages.

The problems of a spatially distributed infeed are solved, or at least alleviated, by the grouping of generating installations in the decoupled sub-grids 10, and by the infeeding at the central infeed connection 30 via the converters 20. As a result, the structure and functioning of the existing energy supply grid can be almost entirely retained. The need for grid expansion measures is significantly reduced.

A further significant aspect of the example embodiment according to FIG. 2 resides in the possibility of functioning largely without communication. Unlike many already known concepts, communication can be implemented within the decoupled sub-grids 10 of the power plant installation 5, i.e. between the energy-generating units, the energy storage units and the converters 20 without a separate communication line, but can be effected by way of conventional droop controllers, using the electrical state variables such as frequency or voltage, in the decoupled sub-grid 10. As a result, the reliability of the existing system is not impaired, and remains at a high level.

In addition to the hydrogen reconversion in gas turbines or engine-based cogeneration systems (BHKW), it is also optionally possible to use further conventional energy conversion systems that work sequentially (e.g. diesel generators, gas turbines, engine-based cogeneration systems), as well as easily controllable energy loads (e.g. power-to-heat systems, e.g. for generating district heating) in the power plant installation 5 according to FIG. 2. With the use of both approaches, the efficiency and reliability of the power plant installation 5 according to FIG. 2 could be improved yet further.

Overall, the power plant installation 5 according to FIG. 2 offers the possibility of achieving, at the infeed connection 30, a behavior that is the same as, or at least approximates to, that of a conventional power plant. It is only thus that conventional generating capacities in the rest of the external energy supply grid 40 can be replaced and switched off, and the changeover to a regenerative energy supply becomes possible.

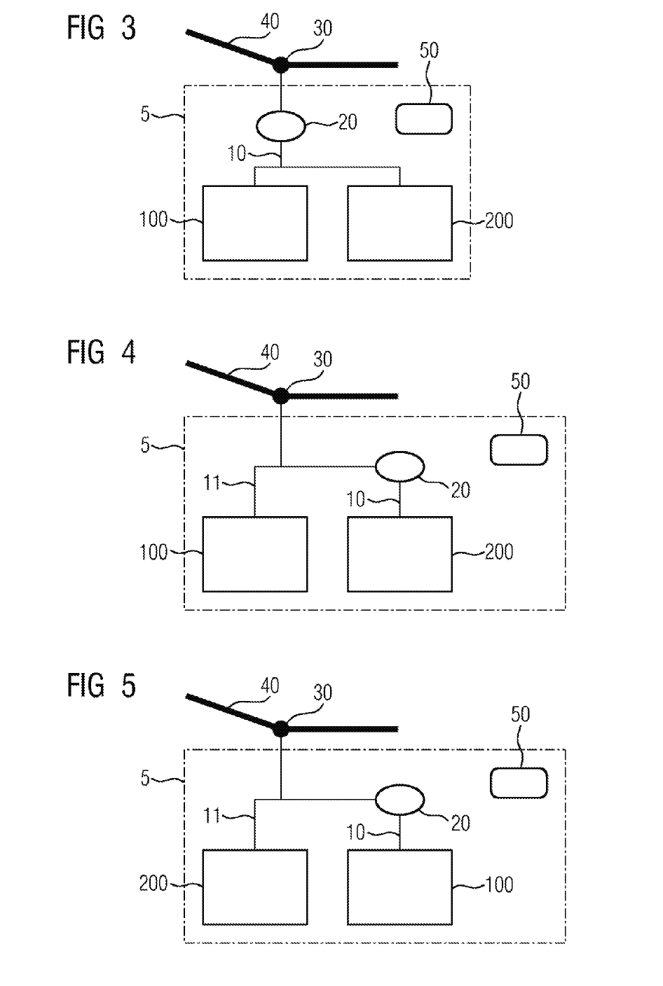

FIGS. 3 to 5 show further development variants for a power plant installation 5 according to an embodiment of the invention, each installation variant having at least one energy-generating unit 100, at least one energy storage unit 200, at least one decoupled sub-grid 10, a controller 50 and an infeed point 30 into an external energy supply grid 40 in the form of an AC grid.

In the case of the example embodiment for a power plant installation according to an embodiment of the invention in FIG. 3, the power plant installation 5 has only one decoupled sub-grid 10, which contains an energy-generating unit 100 and an energy storage unit 200.

By contrast, the power plant installations 5 of the example embodiments in FIGS. 4 and 5 each have a decoupled sub-grid 10 and a directly coupled sub-grid 11.

In FIG. 4, the decoupled sub-grid 10 of the power plant installation 5 contains an energy storage unit 200, and the directly coupled sub-grid 11 has an energy-generating unit 100. In FIG. 5, the decoupled sub-grid 10 of the power plant installation 5 has an energy-generating unit 100, and the directly coupled sub-grid 11 contains an energy storage unit 200.

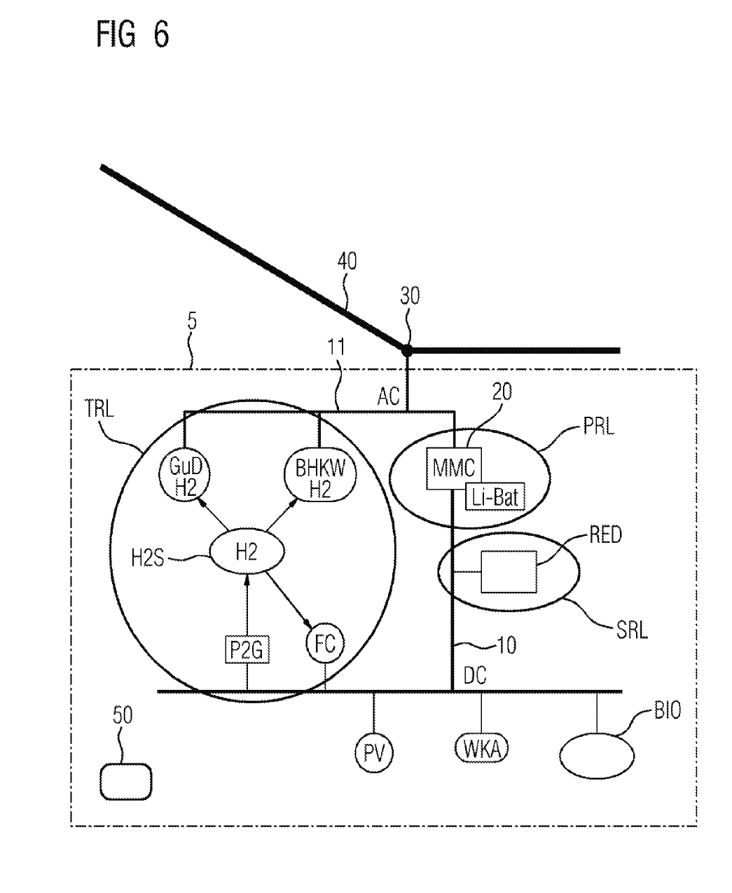

FIGS. 6 to 8 show further advantageous development variants for a power plant installation 5 according to an embodiment of the invention. In the case of the example embodiments according to FIGS. 6 to 8, the power plant installation 5 in each case has a sub-grid 10 that is decoupled from the infeed connection 30 via a converter 20, and a sub-grid 11 that is directly connected to the infeed connection 30. The controlling of the energy-generating units or energy storage units connected to the decoupled sub-grid 10 is preferably effected by the controller 50, by way of droop controllers, not shown, using electrical state variables, in the decoupled sub-grid 10.

The energy-generating units and/or energy storage units connected to the directly coupled sub-grid 11 are controlled by the controller 50, preferably via communication paths, not shown; for this purpose, the energy-generating units and/or energy storage units connected to the directly coupled sub-grid 11, and the controller 50, preferably each have a suitable communication module.

In a manner similar to conventional power plants, the power plant installations 5 according to FIGS. 6 to 8 can provide primary control power PRL, secondary control power SRL and tertiary control power TRL, which may be realized, respectively, by lithium-ion batteries Li-Bat, redox flow batteries RED and P2G systems (see FIGS. 6 to 8). A reconversion of hydrogen H2 stored in a hydrogen storage H2S may be effected by way of a gas and steam power plant GuD, an engine-based cogeneration system BHKW or a fuel cell FC.

A further function of the energy storages resides in evening out the energy generation fluctuations of the fluctuating photovoltaic installations PV, and in evening out the energy generation fluctuations of the wind power installations WKA. Biogas installations BIO are conceivable as further flexible generating installations that may be used.

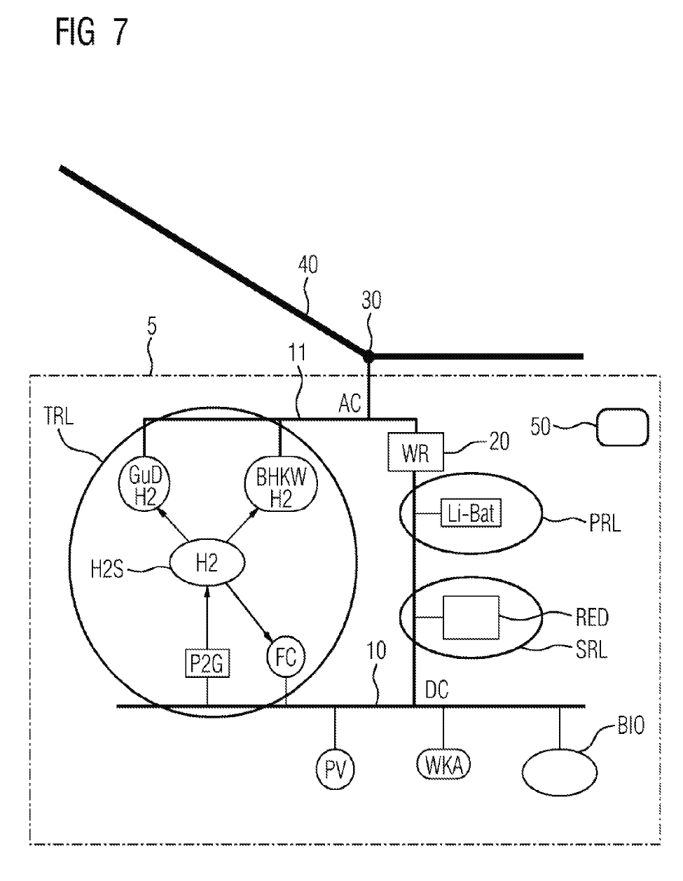

In FIGS. 6 and 7, the power plant's own decoupled sub-grid 10 is realized as a DC (direct-current) grid. The communication within the decoupled sub-grid 10 is preferably effected using the level of the direct voltage (DC voltage) in the decoupled sub-grid 10. If this voltage is too high, for example, there is too much energy present in the decoupled sub-grid 10, and the storages are charged. If it is too low, the storages are discharged.

In the case of the example embodiment according to FIG. 7, the converter 20 is realized as a conventional 2-point converter WR, and the lithium battery storage system is directly connected to the decoupled sub-grid. By contrast, in the case of the example embodiment according to FIG. 6, a modular multilevel converter MMC is used. In this case, the lithium batteries Li-Bat may be directly integrated into the modules of the modular multilevel converter MMC, whereby scaling is rendered possible by way of the number of modules of the modular multilevel converter MMC, instead of by way of a parallel connection of many battery storages, with correspondingly high currents.

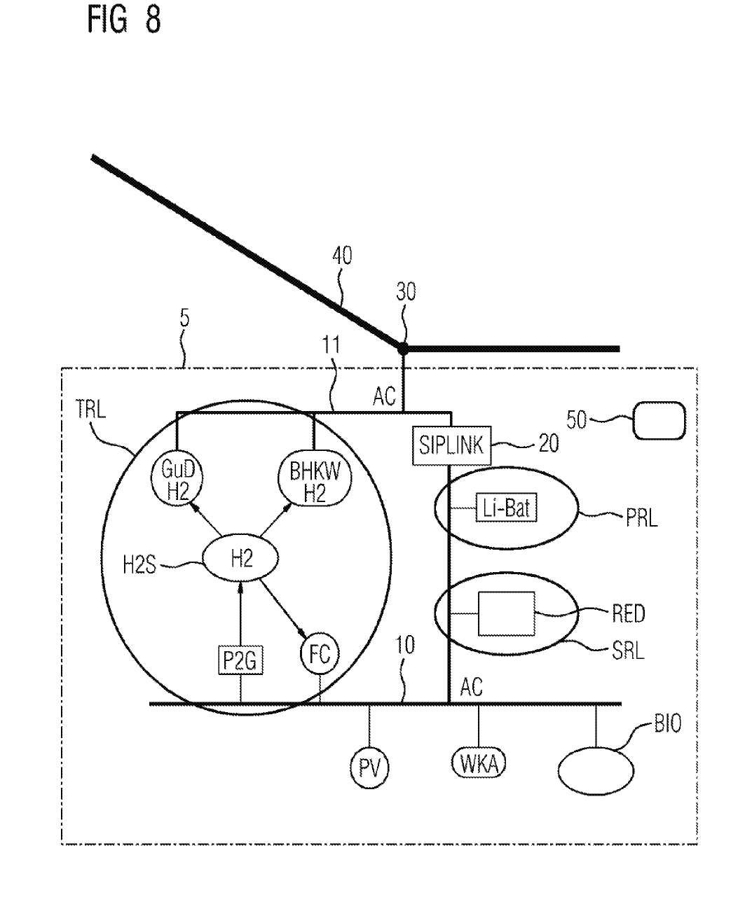

In the case of the example embodiment according to FIG. 8, the decoupled sub-grid 10 is operated with alternating voltage AC, the decoupled sub-grid 10 being decoupled from the external energy supply grid 40 via an AC-AC converter in the form of a back-to-back link (e.g. SIPLINK by the company Siemens AG). As a result, here likewise the state variables of the internal grid (voltage and frequency) can be used as communication between the elements of the decoupled sub-grid 10.

Irrespective of the internal realization, with direct current or alternating current, various embodiment types may exist for power plant installations 5, which differ in the extent to which the infeed at the infeed connection 30 is decoupled from the generation of the renewable energies. An overview relating to this is given in the following table, divided according to type:

| Designation | Characteristic | Properties | Application |
|---|---|---|---|
| Type 1 | Maintenance of | Storages even | Reduction of |
| | RE (renewable- | out | balancing |
| | energy) infeed | discrepancies | reserves in |
| | forecasts | between infeed | the AC grid 40 |
| | | forecasts | |
| | | (schedule) and | |
| | | actual RE | |
| | | generation | |
| Type 2 | Partial | Smoothing and | Medium-load |
| | decoupling of | limited | and peak-load |
| | RE generation | shifting of | power plant |
| | and grid | the | |
| | infeed | fluctuating | |
| | | generation | |
| | Load-dependent | Not always on | |
| | infeed | the grid, | |
| | schedule, but | covering of | |
| | taking RE | peak and | |
| | generation | medium loads | |
| | into account | | |
| Type 3 | Complete | Displacement | Base-load |
| | decoupling of | of infeed | power plant |
| | RE generation | peaks in | |
| | and grid | periods of | |
| | infeed | little/no RE | |
| | | generation | |
| | Fully | Requires large | |
| | load-dependent | storages and | |
| | infeed | flexibly | |
| | schedule | deployable | |
| | possible | generation, | |
| | | e.g. P2G | |
| | | reconversion | |
| | | or biogas | |
| | | installations | |

Accordingly, in the case of a Type 1 power plant installation, the grid infeed and the renewable-energy generation are still coupled to a relatively great extent, despite a decoupled sub-grid, only discrepancies between infeed forecasts and actual renewable-energy generation being evened out.

In the case of a Type 2 power plant installation, grid infeed and renewable-energy generation are partly decoupled, i.e. a limited shifting of the fluctuating generation is possible. The power plant installation is only on the grid at certain times, and therefore is similar to a medium-load or peak-load power plant.

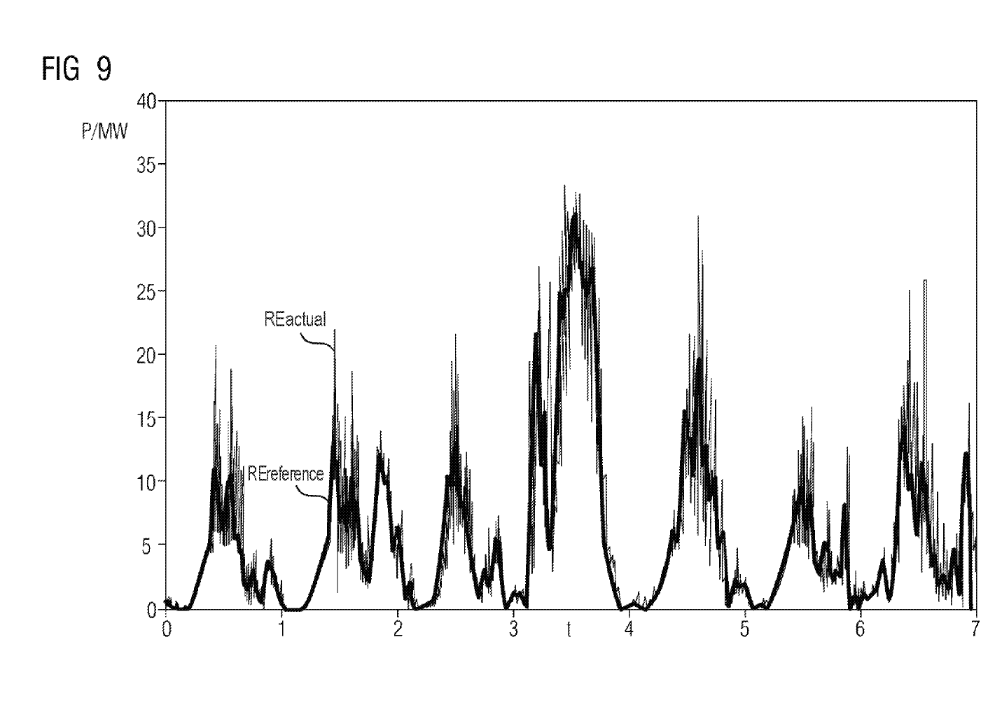

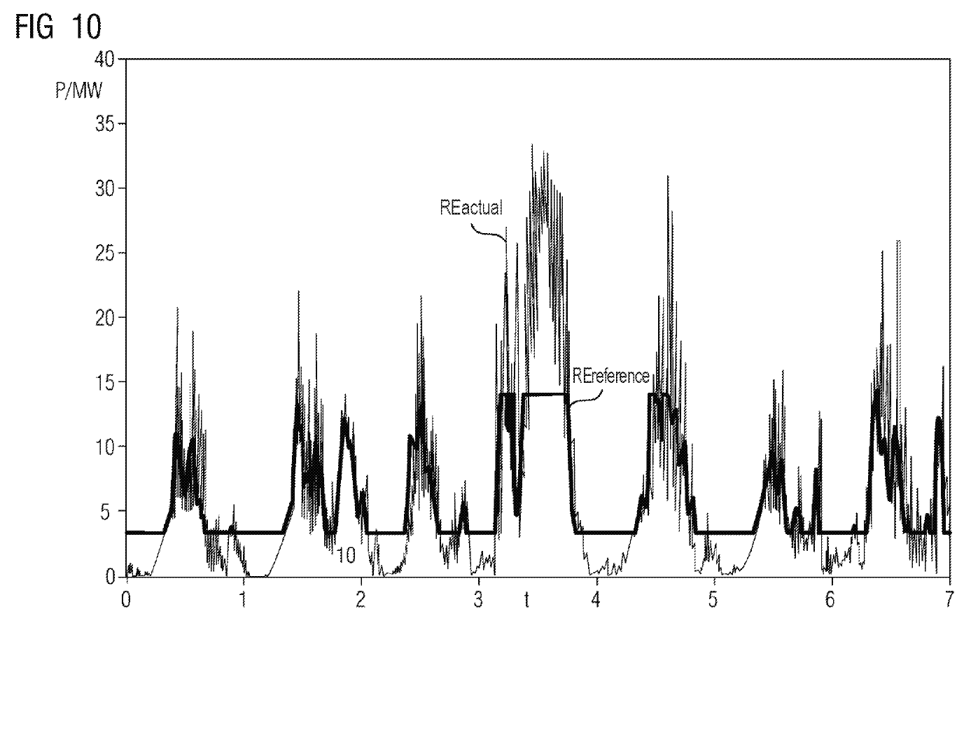

Represented by way of example in FIGS. 9 and 10 are power variation curves (power P in megawatts over time t in days, REactual: actual variation curve of the infeed, REreference: reference variation curve of the infeed) for an example configuration of a power plant installation 5, in which three PV installations, with a total of 6.5 MW, and two wind parks, with a total of 28 MW power, are interconnected via a DC line of approximately 6 km in length. The connection to the AC grid (alternating-voltage grid) 40 is effected, for example, directly at the infeed point 30, which is at a distance of 8 km, via a 110/20 kV transformer substation. Specifically, FIGS. 9 and 10 show the power variation curves for a week in April, once for a Type 1 power plant installation, in which the renewable-energy infeed is only slightly smoothed, and once for a Type 3 power plant installation, in which the infeed peaks are displaced into periods of little infeed, and as a result a secured minimum power is available over the full period.

Although the invention has been illustrated more fully and described in detail on the basis of preferred example embodiments, the invention is not limited by the disclosed examples, and other variations may be derived therefrom by persons skilled in the art, without departing from the scope of protection of the invention.

1. A power plant installation including an infeed connection, for feeding energy into an external energy supply grid, the power plant installation comprising:
at least one energy storage unit;
at least one decoupled sub-grid, connected to the infeed connection via a converter of the power plant installation and electrically decoupled from the infeed connection and the external energy supply grid by the converter;
at least one energy-generating unit, at least one of the at least one energy-generating unit and the at least one energy storage unit being connected to the decoupled sub-grid; and
controller that to, by controlling at least one of the converter, the at least one energy generating unit and the at least one energy storage unit, adjusts infeed behavior of the power plant installation acting outwardly on the infeed connection.

2. The power plant installation of claim 1, further comprising:
at least one regenerative energy-generating unit.

3. The power plant installation of claim 1, further comprising:
at least two regenerative energy-generating units, the at least two regenerative energy-generating units differing from each other in respect of at least one of their energy-generating characteristic and their energy-generating technology.

4. The power plant installation of claim 1, wherein the at least one energy storage unit includes at least two energy storage units, differing from each other in respect of their storage characteristic.

5. The power plant installation of claim 1, wherein the at least one energy storage unit includes
at least two energy storage units, differing from each other in respect of their storage technology.

6. The power plant installation of claim 1, wherein the controller includes a plurality of droop controllers for controlling of the energy-generating units and of the energy storage units present in the decoupled sub-grid, using electrical state variables, in the decoupled sub-grid.

7. The power plant installation of claim 1, wherein at least one sub-grid is directly coupled to the infeed connection of the power plant installation, and at least one of the at least one energy storage unit and the and/or at least one energy-generating unit is connected to the directly coupled sub-grid.

8. The power plant installation of claim 7,
wherein the at least one energy storage unit includes a plurality of energy storage units, at least one of the plurality of energy storage units connected to the directly coupled sub-grid and at least one of the plurality of the energy-generating units connected to the directly coupled sub-grid each including a communication module to enable communication with the controller.

9. The power plant installation of claim 1, wherein the controller, the at least one energy storage unit and the at least one energy-generating unit is realized in such a manner that the power plant installation is capable of at least one of running predefined infeed schedules, rendering predefined grid services and providing electrical energy having predefined electrical parameters.

10. The power plant installation of claim 1, wherein the controller, the at least one energy storage units and the at least one energy-generating unit are realized in such a manner that the infeed behavior of the power plant installation is configured to emulates the infeed behavior of a conventional power plant.

11. The power plant installation claim 1, wherein the at least one energy storage unit and the at least one energy-generating unit is disposed at a distance from each other.

12. A method for operating a power plant installation connected to an external energy supply grid via an infeed connection of the power plant installation and including at least one energy-generating unit, the method comprising:
feeding at least one of energy of the at least one energy-generating unit and energy of at least one energy storage unit into an own sub-grid of the power plant; and
either
feeding generated energy of the at least one energy-generating unit into the external energy supply grid either directly, via the infeed connection, or via a converter and the infeed connection, or
entirely or at least in part storing the generated energy of the at least one energy-generating unit intermediately in the at least one energy storage unit.

13. The method as claimed in claim 12, wherein a proportion of energy that is stored intermediately is determined in dependence on a predefined infeed schedule or a defined grid service.

14. The method of claim 12, wherein the controlling of the converter, the at least one energy-generating unit and the at least one energy storage unit is effected in such a manner that the infeed behavior of the power plant installation emulates the infeed behavior of a conventional power plant.

15. The power plant installation of claim 3, wherein the at least one energy storage unit includes at least two energy storage units, differing from each other in respect of their storage characteristic.

16. The power plant installation of claim 3, wherein the at least one energy storage unit includes at least two energy storage units, differing from each other in respect of their storage technology.

17. The power plant installation of claim 2, wherein at least one sub-grid is directly coupled to the infeed connection of the power plant installation, and at least one of the at least one energy storage unit and the at least one energy-generating unit is connected to the directly coupled sub-grid.

18. The power plant installation of claim 17, wherein the at least one energy storage unit includes a plurality of energy storage units, at least one of the plurality of energy storage units connected to the directly coupled sub-grid and at least one of the plurality of the energy-generating units connected to the directly coupled sub-grid each including a communication module to enable communication with the controller.

19. The power plant installation of claim 3, wherein at least one sub-grid is directly coupled to the infeed connection of the power plant installation, and at least one of the at least one energy storage unit and the at least one energy-generating unit is connected to the directly coupled sub-grid.

20. The power plant installation of claim 19, wherein the at least one energy storage unit includes a plurality of energy storage units, at least one of the plurality of energy storage units connected to the directly coupled sub-grid and at least one of the plurality of the energy-generating units connected to the directly coupled sub-grid each including a communication module to enable communication with the controller.

21. The method of claim 13, wherein the controlling of the converter, the at least one energy-generating unit and the at least one energy storage unit is effected in such a manner that the infeed behavior of the power plant installation emulates the infeed behavior of a conventional power plant.
